(19) United States
(12) Patent Application Publication
(10) Pub. No.: US 2024/0273501 A1
(43) Pub. Date: Aug. 15, 2024

(54) COMPUTERIZED SYSTEM WITH ASSET REGISTRY SERVER

(71) Applicant: OLYN, INC., San Jose, CA (US)

(72) Inventor: Ana Maria JIPA, Barcelona (ES)

(21) Appl. No.: 18/568,626

(22) PCT Filed: Mar. 15, 2023
(86) PCT No.: PCT/US2023/064435

§ 371 Date: Dec. 8, 2023

Related U.S. Application Data
(60) Provisional application No. 63/269,367, filed on Mar. 15, 2022.

(51) Int. Cl. G06Q 20/20; G06Q 30/012; G06Q 30/0601

(52) U.S. Cl. CPC G06Q 20/209; G06Q 30/012; G06Q 30/0601

(57) ABSTRACT

A computerized system is provided including an asset registry server configured to receive an asset token template generation request, create an asset record template for a product, receive manufacturer content related to the product, store the manufacturer content associated with the asset record template, and send an asset identifier for the asset record template to a point-of-sale system. Further, the asset registry server is configured to receive an asset token request from the point-of-sale system in response to a user purchasing a product associated with the asset identifier, generate an asset token, create a new asset record in the asset record database including the generated asset token or including a link to the generated asset token on a publicly accessible ledger, and send the asset token or link to the point-of-sale system for transmission to an owner client device of the owner purchasing the product.

### CROSS-REFERENCE TO RELATED APPLICATIONS

The present application is a national phase application of PCT application number PCT/US2023/064435, titled COMPUTERIZED SYSTEM WITH ASSET REGISTRY SERVER, filed Mar. 15, 2023, which claims the benefit of and priority to U.S. provisional patent application No. 63/269,367, titled PLATFORM FOR DIGITAL REGISTRY OF ASSETS, filed Mar. 15, 2022. The entire contents of these priority applications are incorporated herein by reference in their entirety for all purposes.

### BACKGROUND

In modern society, people accumulate assets. Over time, it is common for a person to acquire furniture, household appliances, smartphones, tablets, computers, televisions, vehicles, tools, clothing, handbags, jewelry, and numerous other types of possessions. Many of these assets are valuable, and many require care and maintenance throughout their useful life. While many of these assets are accompanied by user manuals, receipts, registry information, and the like, such information is typically in the form of physical paper copies that are cumbersome to organize and store. Some assets may have instructions and registries available in digital format, but accessing the information can be tedious and requires visiting individual sites for each asset. A challenge exists in creating, organizing, and storing asset data in a digital format that is easily transferred and accessible by the owner and interested parties.

### SUMMARY

To address the above issues, a platform for digitally registering assets is disclosed herein. Digital representations of assets are created and registered as asset cards, which allows information relevant to each asset to be programmatically organized and stored, either by a merchant or manufacturer, i.e., creator of the asset, or by the owner of the asset. Such asset cards additionally provide interoperability as an asset is purchased, gifted, or otherwise transferred from the creator to the user, and from user to user as peers. Online reviews, mentions, social media shares, and the like can be indexed to the asset card and viewed by the owners and other parties interested in the asset. Further, values of assets over time can be digitally stored and maintained in a secured framework.

According to one aspect of the present disclosure, a computerized system is provided, comprising an asset registry server including one or more processors each having associated memory storing instructions that when executed cause the one or more processors to, in a set up phase: receive an asset token template generation request from a manufacturer client device, the request being associated with a product of a manufacturer: create an asset record template specific to the product from a generic asset template, wherein the asset record template includes an asset identifier: store the asset record template with the asset identifier in an asset record database: receive manufacturer content related to the product from the manufacturer client device: store the manufacturer content in the asset record database in a manner associated with the asset record template; and send the asset identifier to a point-of-sale system to cause the point-of-sale system to associate the product with the asset identifier. Further, the one or more processors are configured to, in a purchase transaction phase, receive at the asset registry server an asset token request along with an asset identifier of the product from the point-of-sale system, the token request being sent in response to a purchase transaction by which an owner acquires as an asset a unit of the product at the point-of-sale system; and in response to the asset token request, generate an asset token based on the asset record template associated with the received asset identifier, create a new asset record in the asset record database including the generated asset token or including a link to the generated asset token on a publicly accessible ledger, and send the asset token or a link to the asset token to the point-of-sale system for transmission to an owner client device of the owner purchasing the product.

In this aspect, the manufacturer content can include one or more of a buy again link for the product, a link to purchase an accessory for the product, a link to purchase a warrantee for the product, a link an electronic manual for the product, and/or an electronic manual for the product.

Further in this aspect, the point-of-sale system can be a point-of-sale terminal in a brick-and-mortar store.

Further in this aspect, the point-of-sale system can be configured to produce a digital receipt for the purchase transaction that includes the asset token or a link to the asset token and is sent wirelessly from the point-of-sale system to an owner client device.

Further in this aspect, the point-of-sale system can be configured to produce a physical receipt that includes a code or optical pattern printed on the physical receipt, which code or optical pattern is readable by a camera or other input device of an owner client device, the owner client device being configured to read the code or optical pattern and download the asset token or a link to the asset token from the asset registry server.

Further in this aspect, the point-of-sale system can be an e-commerce website or application executed on an owner client device.

Further in this aspect, the asset token can be a non-fungible token, and can be generated by and written to a publicly accessible blockchain ledger, and the asset record in the asset record database can include a link to the non-fungible token on the blockchain ledger. In this aspect, a record of the purchase transaction from the point-of-sale system of the merchant to the owner client device also can be recorded on the blockchain ledger for the asset token.

Further in this aspect, the asset token can be a globally unique identifier, and can be written to a private ledger maintained by the asset registry system along with the purchase transaction.

Further in this aspect, the asset registry server can be further configured to receive from a wallet application executed on the owner client device: a request to upload owner content and/or modify metadata associated with the asset record to the asset registry server; and/or a request to download and view manufacturer content or third-party content from the asset registry server.

Further in this aspect, the wallet application can be further configured to execute a transfer transaction to transfer the asset token from the wallet application of the owner client device to a peer wallet application of a peer client device, and send a request to the blockchain ledger to record the transfer transaction. In this aspect, the asset registry server is further configured to receive, from a peer client device executing a peer wallet application that has received a transfer of the asset token from the owner wallet application, an asset record request, and in response to receiving the asset record request, create an asset record associated with the asset token at the peer client device in the asset record database, and following creation of the is further configured to receive an upload of peer content from the peer client device to be associated with the asset record. Also in this aspect, the owner content and/or peer content can be designated as sharable so as to be viewably by other users of the asset registry server.

Further in this aspect, the asset registry server can be configured to: receive, from a third-party client device of a third-party owner who owns as an asset another unit of the product, a request to create a third-party asset record including a different asset token or a link to the asset token based on the asset record template with the asset identifier; and receive, from the third-party client device, an upload of third-party content and sharing permissions for the third-party content associated with the third-party asset record. In this aspect, the asset registry server can be configured to serve a graphical user interface including: manufacturer content associated with the asset record template having the asset identifier for the product: owner content associated with the owner asset record for the unit of the product; and third-party content associated with the third-party asset record for the different unit of the product.

According to another aspect of the present disclosure, a computerized method is provided, including at an asset registry server: in a set-up phase: receiving an asset token template generation request from a manufacturer client device of a manufacturer, the request being associated with a product of the manufacturer: creating an asset record template specific to the product from a generic asset template, wherein the asset record template includes an asset identifier: storing the asset record template with the asset identifier in an asset record database: receiving manufacturer content related to the product from the manufacturer client device: storing the manufacturer content in the asset record database in a manner associated with the asset record template; and sending the asset identifier to a point-of-sale system to cause the point-of-sale system to associate the product with the asset identifier. Further, the method may include, in a purchase transaction phase: receiving at the asset registry server an asset token request along with an asset identifier of the product from the point-of-sale system, the token request being sent in response to a purchase transaction by which an owner acquires as an asset a unit of the product at the point-of-sale system; and in response to the asset token request, generating an asset token based on the asset record template associated with the received asset identifier: creating a new asset record in the asset record database including the generated asset token or including a link to the generated asset token on a publicly accessible ledger; and sending the asset token or a link to the asset token to the point-of-sale system for transmission to an owner client device of the owner purchasing the product.

In this aspect, the method can further include receiving from a wallet application executed on the owner client device: a request to upload owner content and/or modify metadata associated with the asset record to the asset registry server; and/or a request to download and view manufacturer content or third-party content from the asset registry server.

Further in this aspect, the method can include receiving, from a third-party client device of a third-party owner who owns as an asset another unit of the product, a request to create a third-party asset record including a different asset token based on the asset record template with the asset identifier; and receiving, from the third-party client device, an upload of third-party content and sharing permissions for the third-party content associated with the third-party asset record.

Further in this aspect, the method can include serving a graphical user interface including: the manufacturer content associated with the asset record template having the asset identifier for the product: the owner content associated with the owner asset record for the unit of the product; and the third-party content associated with the third-party asset record for the different unit of the product.

According to another aspect of the present disclosure, a computer system is provided that can include an asset registry server including one or more processors each having associated memory storing instructions that when executed cause the one or more processors to, in a set-up phase: receive an asset token template generation request from a manufacturer client device, the request being associated with a product of a manufacturer; create an asset record template specific to the product from a generic asset template, wherein the asset record template includes an asset identifier: store the asset record template with the asset identifier in an asset record database: receive manufacturer content related to the product from the manufacturer client device, wherein the manufacturer content includes one or more of a buy again link for the product, a link to purchase an accessory for the product, a link to purchase a warrantee for the product, a link an electronic manual for the product, and/or an electronic manual for the product: store the manufacturer content in the asset record database in a manner associated with the asset record template: send the asset identifier to a point-of-sale system to cause the point-of-sale system to associate the product with the asset identifier. Further, in this aspect, the one or more processors can be configured to, in a purchase transaction phase, receive at the asset registry server an asset token request along with an asset identifier of the product from the point-of-sale system, the token request being sent in response to a purchase transaction by which an owner acquires as an asset a unit of the product at the point-of-sale system; and in response to the asset token request, generate an asset token based on the asset record template associated with the received asset identifier, wherein the asset token is a non-fungible token, and is generated by and written to a publicly accessible blockchain ledger, and the asset record in the asset record database includes a link to the non-fungible token on the blockchain ledger: create a new asset record in the asset record database including the generated asset token or including a link to the generated asset token on a publicly accessible ledger; and send the asset token or a link to the asset token to the point-of-sale system for transmission to an owner client device of the owner purchasing the product, wherein said transmission to the owner client device occurs via a physical or digital receipt for the purchase transaction that includes the asset token or the link to the asset token.

### BRIEF DESCRIPTION OF THE DRAWINGS

FIG. 1 is a schematic illustration of physical assets digitally registered with a computing system including an asset registry server system according to one embodiment of the present description.

FIG. 2 is a schematic diagram of the computing system of FIG. 1, showing the asset registry server system including a plurality of servers each implementing an application programing interface for interfacing with client computing devices to enable registration of physical assets in a digital registry of physical assets.

FIG. 3 is a schematic illustration of the computing system of FIG. 1, showing asset records presented as cards to users by the digital registry of physical assets.

FIG. 4 shows an asset record presented as an example standard card for a digitally registered physical asset.

FIG. 5 shows an asset record presented as an example unit card for a digitally registered physical asset.

FIG. 6 is a schematic diagram illustrating another view of the computing system of FIGS. 1-5, showing certain hardware and software components of one asset registry server of the asset registry server system in detail, along with an example manufacturer client device, point-of-sale system, owner client device, peer client device, and third party client device.

FIG. 7 is a schematic diagram illustrating a graphical user interface of a wallet application of the computing system of FIG. 6.

FIG. 8 is a flowchart of a computerized method according to one example of the present disclosure.

FIG. 9 is a continuation of the flowchart of FIG. 8.

FIG. 10 is an example computing environment that may be used to implement the devices, systems, and methods of FIGS. 1-9.

### DETAILED DESCRIPTION

Selected embodiments of the present disclosure will now be described with reference to the accompanying drawings. It will be apparent to those skilled in the art from this disclosure that the following descriptions of the embodiments of the disclosure are provided for illustration only and not for the purpose of limiting the disclosure as defined by the appended claims and their equivalents.

It is common for people to own a wide variety of assets, as discussed above. Such assets are generally physical objects, and come with user manuals, receipts, registry information, and the like, but may also include non-physical (e.g., digital) assets accompanied by non-fungible tokens (NFTs). A challenge exists in organizing and storing such data to be easily accessible by a merchant or manufacturer, i.e., creator of the asset, or by the owner of the asset, following acquisition of the assets by a user, throughout the lifecycle of the asset including subsequent transfers of ownership, and to enable users who possess similar assets to share information related to the asset, both with the original manufacturer and with each other.

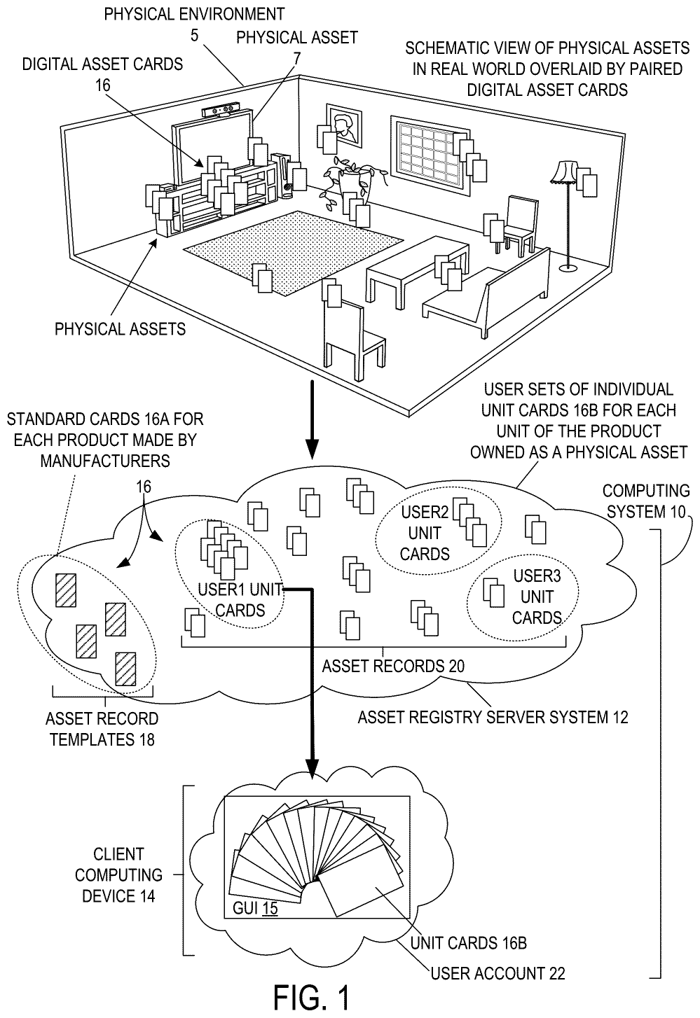

The computing system 10 described herein provides a solution to persons interested in storing and keeping track of their assets, both physical and non-physical. Turning initially to FIG. 1, an example of a computing system 10 for digitally registering physical assets is illustrated, including an asset registry server system 12 and a client computing device 14. As shown in the top panel, an example physical environment 5 is shown that includes physical assets 7 such as furniture, appliances, computers, decorative wall art, and the like. These assets 7 are units of products, which have been purchased by an owner, also referred to herein as a user. In the present computing system 10, each of these assets 7 can be registered, and an asset record template 18 can be used to create an asset record 20 associated with the asset 7. The asset records 20 may be presented to the user via a graphical user interface 15 of client computing device 14 as a graphical digital asset card 16. The asset records 20 for these digital asset cards 16 thus can be stored in the cloud at the asset registry server system 12, as shown in the middle panel of FIG. 1. The bottom panel of FIG. 1 illustrates how, taken together, the asset cards can be displayed on graphical user interface 15 as a “deck” of asset cards 16 for items owned by a same owner, thereby collecting and organizing aspects of each of the assets 7 in a single virtual location, i.e., a user account 22 at the asset registry server system 12 accessed by the owner using the client computing device 14. In this way, the owner can easily access and view information about any given 7 asset owned by the owner and registered with the asset registry server system 12.

As described in detail below, asset cards 16 may take the form of a standard card 16A or a unit card 16B. A standard card 16A is created by a merchant or manufacturer, which sends a request to the assert registry server system 12 to create an asset record template 18 for a product. A unit card 16B and corresponding asset record 20 is added to the user account 22 for the owner when an instance or unit of the product represented by a standard card 16A is purchased by a user, as described in detail below.

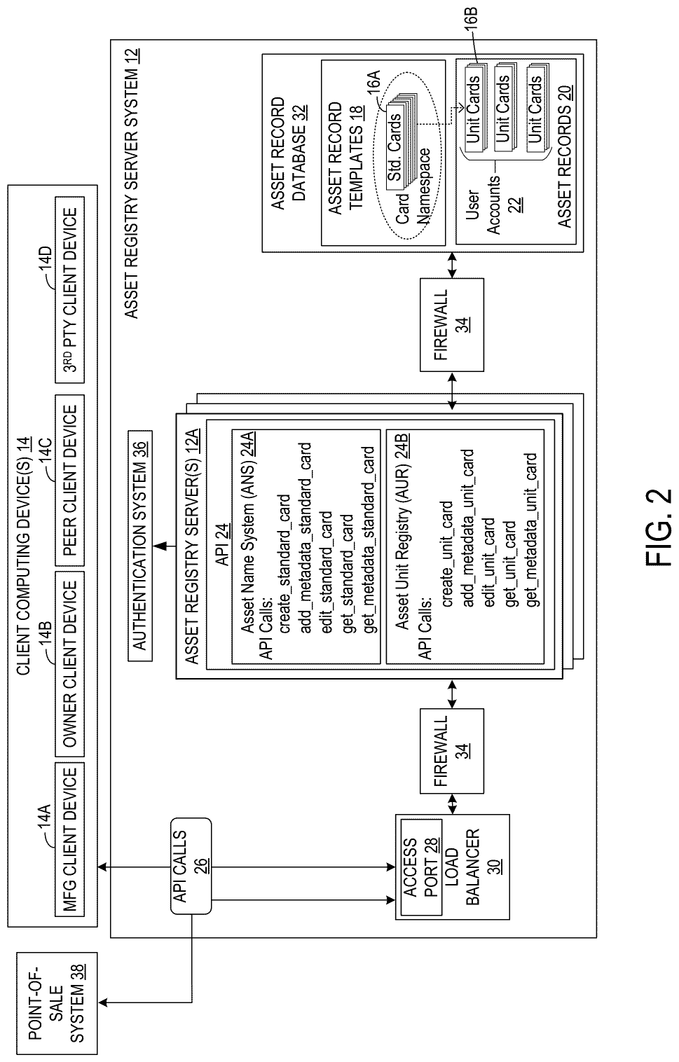

FIG. 2 shows a schematic diagram of the asset registry server system 12, featuring an application programming interface (API) 24 for the digital registry of assets. One or more client computing devices 14 can be configured to communicate with an asset registry server system 12 via API calls 26, or communications of another type. Examples of client computing devices 14 include a manufacturer client device 14A, owner client device 14B, peer client device 14C, and third-party client device 14D. Incoming API requests of API calls 26 from the client computing devices 14 to access the API 24 of the asset registry server system 12 come through access port 28 of load balancer 30 and are distributed across endpoint asset registry servers 12A within the asset registry server system 12 via the load balancer 30. The API 24 is executed on each of the asset registry servers 12A, and retrieves data necessary to service the API calls 24 by making backend database calls to an asset registry database 32. Firewalls 34 on either side of the asset registry servers 12A monitor and filter traffic to the asset registry servers 12A and from the asset registry servers 12 to the asset registry database 28, for security. Access by the various users of the client computing devices 14 to the API 24 served by the servers 12A is authenticated and managed via an authentication system 36 that implements a token-based single sign on, such as Auth0, for example, or other suitable authentication and authorization protocol. The asset registry server system 12 is also configured to communicate with a point-of-sale system 38 via API calls 26. Further information on the interchange between the point-of-sale system 38 and the asset registry server system 12 is provided below.

The API 24 contains API endpoints that the client computing devices 14 can call to create and manage standard card 16A and unit cards 16B. The API 24 has two primary paths: the asset name system (ANS) 24A and the asset unit registry (AUR) 24B. The ANS 24A is used to create a standard card 16A. A standard card 16A represents a product that can have multiple units sold as assets to individual consumers, and functions similarly to a prototype or template for unit cards. Typically, only developers who have obtained proper developer credentials with the asset registry server system 12 are authorized to use the APIs to create and modify standard cards 16A. And typically, those authorized developers are employed or authorized by manufacturers of the products and thus access the asset registry server system 12 via the manufacturer client device 14A. The creation of a standard card 16A requires registration of the asset name for the product, and the resultant asset name registry functions akin to a username lookup service, domain name service, or Ethereum name service for products with standard cards in the asset registry. The AUR 24B is utilized to create a unit card 16B and register a single unit or instance of an asset. In one example, the registration of the asset 7 occurs at the time of purchase of the instance of the asset 7. Thus, it will be appreciated that businesses who have registered with and obtained business proper credentials from the asset registry server system 12 are authorized to use the API 24 to create and manage unit cards 16B to configure their point of sale systems 38 and manufacturer client devices 14A, and developers associated with these businesses may also be granted such permissions. Unit cards 16B can be created or linked to standard cards 16A, and each unit card 16B has a validated user identity attached to it as the owner of the asset 7. Typically the standard card 16A is populated with asset defining information, which is copied into each unit card 16B instance for the same asset 7, and each unit card 16B can contain additional information defining the particular instance of the asset 7 owned by the user.

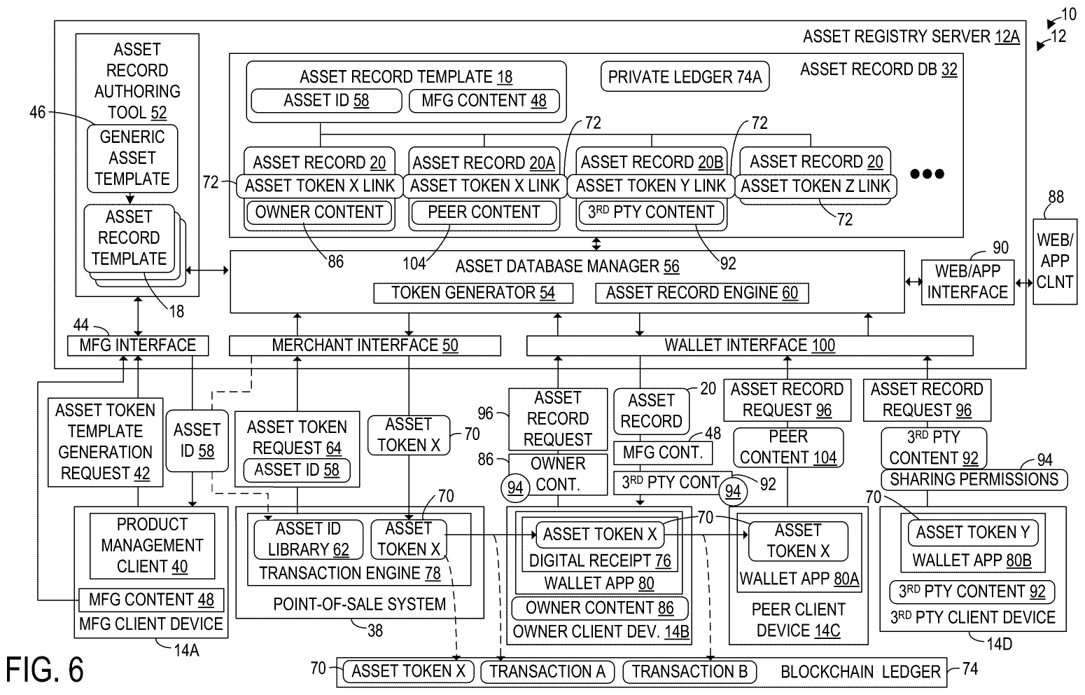

A developer may create an account to access the API 24 by providing their name, telephone number, email address, and a description of the asset, such as a photo or other descriptive data specific to the asset. Information such as a company name (e.g., manufacturer name) and other data related to the developer of the asset 7 may also be entered. In response to the request to use the API 24, the asset registry server system 12 will return a developer API token and confirmation of the developer's account. Once access to the asset registry server system 12 is achieved, the developer may call the API 24 to create a standard card 16A for an asset via the ANS path. It will be appreciated that each standard card 16A includes an asset name that is unique within the asset registry. Thus, the asset registry server system 12 maintains a standard card 16A namespace within its asset record database 32. If a name has already been taken, which is included in a developer's create_standard_card API call, then a failure result is returned, along with an error message indicating the name is in use by another standard card 16A. A similar process may be used by a business, such as an online or bricks-and-mortar retailer, to register an account with the system. Business accounts may be used to facilitate the creation of unit cards 16B that are distributed at the point-of-sale system 38, along with a digital receipt for a product, for example, as described further in relation to FIG. 6.

A user may create an account to access the API 24 by providing at least a telephone number. The user may also provide a name, email address, and/or additional user-related data, but these items of identifying information are not required to use the API 24. In response to the request to sign up and/or log in, the API 24 returns a user access token.

The user may call the API 24 to create a unit card 16B via the AUR 24B path. The API 24 is configured to receive information such as a photo of the asset and/or a receipt of the asset, as well a description of the asset type. The API 24 may optionally receive additional data such as a name or model of the asset 7, a brand of the asset 7, the issuer or creator of the asset 7, descriptive tags related to the asset 7, a brief description of the asset 7, a link to the asset 7, a value of the asset 7, or user identifying information such as a location, device, and/or IP address from which the user created or authorized the asset 7. In response to the request, the API 24 may return a unit card 16B created for the unit of the asset 7 to the user.

Additionally, the user may call the API 24 to add metadata to a unit card 16B, such as a unique identifier of the asset 7 or documents associated with the asset 7, for example. The user inputs the item identification and a name of the package containing the metadata to be added to the unit card 16B, and the API 24 returns the updated asset card 16B or a link thereto.

API calls 24 may also be made to edit a unit card 16B, retrieve a unit card 16B, and/or retrieve metadata from a unit card 16B. To edit a unit card 16B, the user inputs a unique identifier of the asset 7 and a package of information including location information for the data to be modified. In response, the API 24 outputs asset information and permits the user to access and edit metadata for the unit card 16B. To retrieve a unit card 16B, the user inputs a unique identifier of the asset 7, a package name, and a set of parameters related to the asset 7, and the API 24 returns standard data such as a photo, name, and brand of the asset 7, as well as a registry, status, and any added metadata for the asset 7. To retrieve metadata from a unit card 16B, the user inputs a unique identifier of the asset 7, a package name, and a set of parameters related to the asset 7, and the API returns standard data and registry information for the asset, such as a unit identification number, QR code, user identifying information, i.e., an owner ID, a location, device, and/or IP address from which the user created or authorized the asset 7, a date of creation of the unit card, a price paid for the asset, and/or the source of acquisition of the asset 7, as well as any added metadata regarding the asset 7.

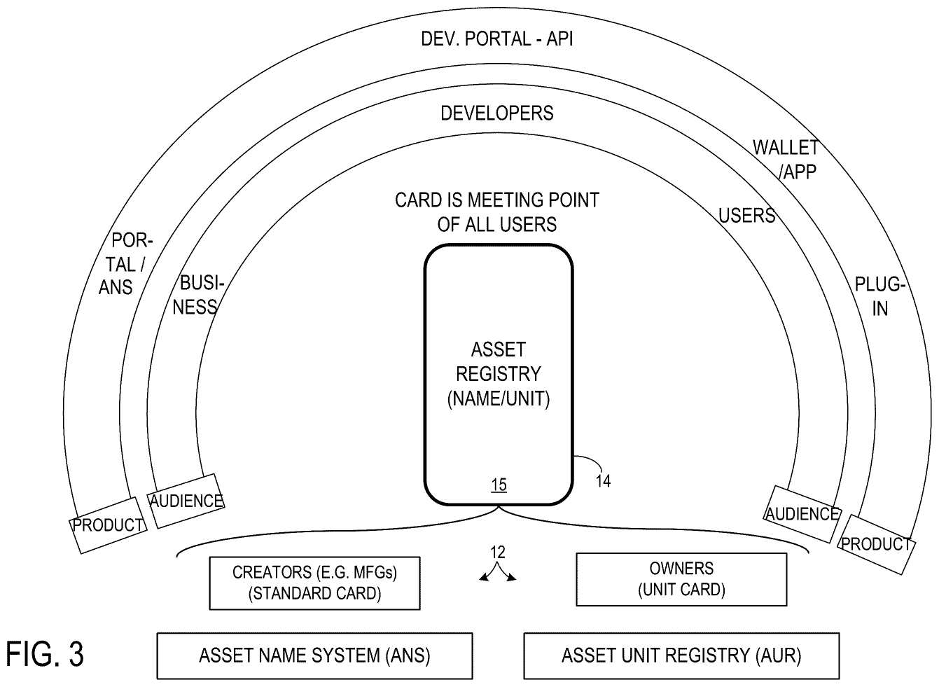

FIG. 3 is a schematic illustration of a view of the computing system of FIG. 1, showing asset records presented as cards to users by the digital registry of physical assets. As shown, the asset registry server system 12 can be utilized as a central source of information for an asset that unites interested parties such as businesses, developers, and users. The asset registry server system 12 provides a platform for merchants and manufacturers to present their products, and for owners of the product to organize information about their assets in a single, easily accessible location in the cloud. Further, potential buyers may research assets of interest using the asset data stored on the standard cards.

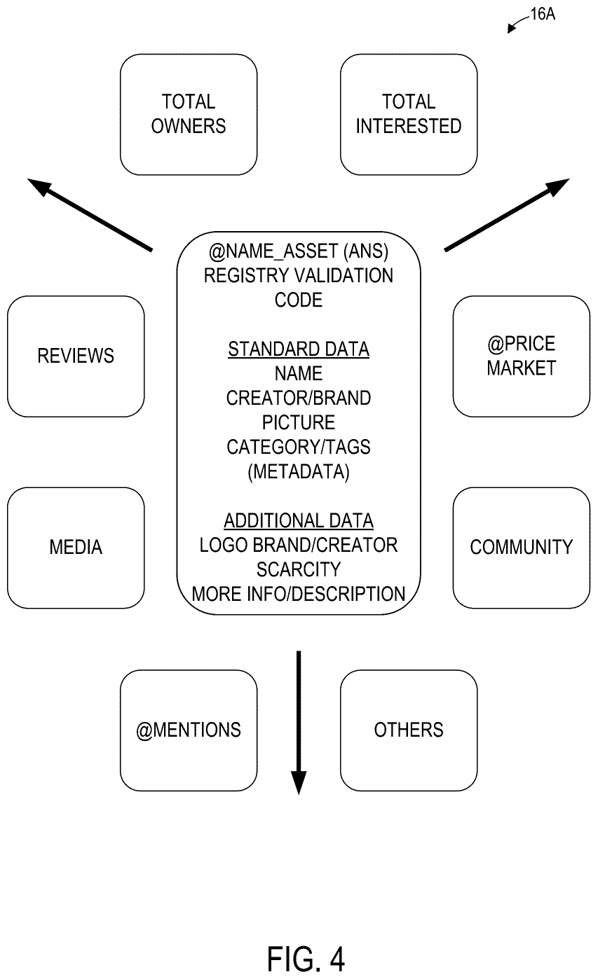

FIG. 4 shows an example representation of the standard card 16A. The standard card may provide information about an asset such as a current market price, as well as links to reviews, mentions, social media posts, news items, and the like regarding the asset. The total number of owners and the total number of interested parties, i.e., potential buyers, may also be provided, which may indicate the market value of the asset. A public set of data regarding the asset that is stored on a standard card is generally accessible by the public, for example via the web/app interface 90 shown in FIG. 6. Additionally backend data regarding access to the standard card, indexing data, etc. may be stored on the asset registry server system 12 for internal use, without making such data public.

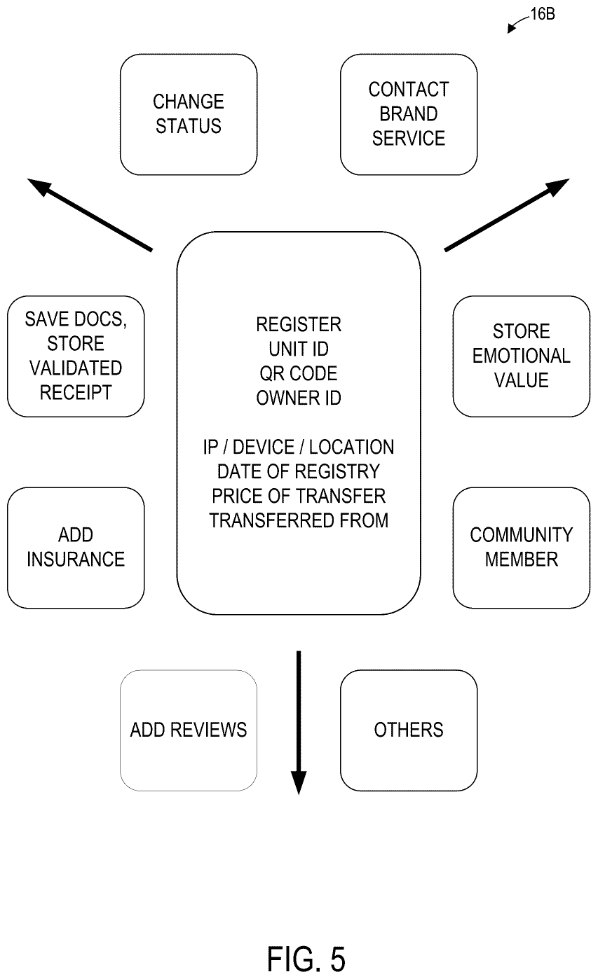

FIG. 5 shows an example representation of the unit card 16B. Information about an asset 7 that is stored on a unit card 16B is private and only accessible to the owner of the instance of the asset that the unit card 16B represents. Unit cards 16B may include information such as a unit identification, QR code, owner identification, and metadata such as documents and receipts pertaining to the asset. The user may include insurance information, reviews, brand contact information, and the like to the unit card 16B.

FIG. 6 illustrates another view of computing system 10, in which the asset registry described above may be implemented. In the above embodiments, the term “card” is used to describe standard cards and unit cards. It will be appreciated that the card is a digital record of data which can be graphically represented as a card, and thus the term “record” can be used instead of “card” to describe the data upon which the card is based. In the implementation described in FIG. 6, the term “asset record template” corresponds to the standards cards described above, and “asset record” corresponds to the unit cards described above.

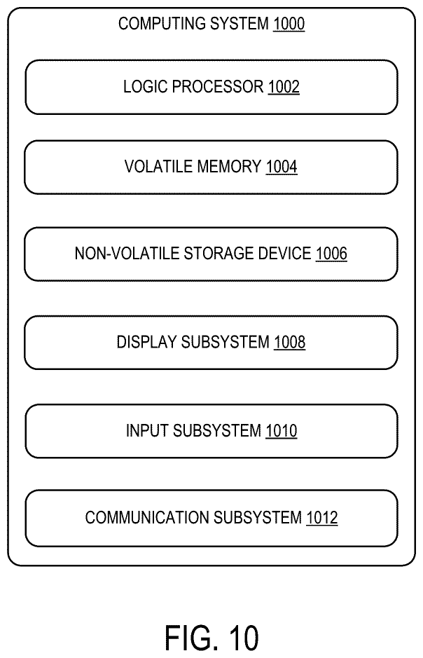

As shown in FIG. 6, computing system 10 includes an asset registry server system 12 including one or more asset registry servers 12A, each including one or more processors (illustrated in FIG. 10) each having associated memory (also (illustrated in FIG. 10) storing instructions that when executed cause the one or more processors to execute the following operations in a set-up phase and one or more transaction phases. In the set-up phase, the manufacturer client device 14A executing a product management client program 40 is used by a manufacturer to send an asset token template generation request 42 to a manufacturer interface 44 of the asset registry server 12A, the request being for a product of the manufacturer. Accordingly, the asset registry server 12A is configured to receive the asset token template generation request 42 from the manufacturer client device 14A, the request being associated with a product of a manufacturer. The asset registry server 12A is configured to create an asset record template 18 specific to the product from a generic asset template 46, wherein the asset record template 18 includes an asset identifier 58, and store the asset record template 18 with the asset identifier 58 in an asset record database 32.

The asset token template generation request 42 may be accompanied by the upload of such manufacturer content 48 from the manufacturer client device 14A to the asset registry server 12A. Thus the asset registry server 12A may further be configured to receive manufacturer content 48 related to the product from the manufacturer client device 14A, and store the manufacturer content 48 in the asset record database 32 in a manner associated with the asset record template 18. The manufacturer content 48 can include one or more of a buy again link for the product, a link to purchase an accessory for the product, a link to purchase a warrantee for the product, a link an electronic manual for the product, and/or an electronic manual for the product. Other content may also be included in the manufacturing content 48 on standard cards 16A as described above, for example. Typically, such an asset token template generation request 42 is made when the manufacturer develops a new product and desires to release it into the marketplace.

More specifically, the manufacturer interface 44 of the asset registry server 12A passes the asset token template generation request 42 and manufacturer content 48 to an asset record authoring tool 52, which can be used by the manufacturer to create an asset record template 18 specific to the manufacturer's product, from a generic asset template 46. Information can be included in the asset record template 18 as is described above for the standard card 16A. The asset record authoring tool 52 sends a request to an asset database manager 56 to generate an asset identifier 58 (e.g., asset name, globally unique identifier (GUID), or other sufficiently unique identifier) the newly generated asset record template 18. An asset record engine 60 of the asset database manager 56 then stores the newly generated asset record template 18 for the manufacturer's product in the asset record database 32, along with the asset identifier 58, the manufacturer content 48 received from the manufacturer, and any other metadata entered by the manufacturer or programmatically generated by the asset record authoring tool 52 at the time of creation. In this way, an asset record template 18 for a new product can be created and stored in the asset record database 32 of the asset registry server 12A.

Following creation of the asset record template 18, the asset identifier 58 can be downloaded to the product management client 40 of the manufacturer client device 14A. This can enable the product management client 40 to correspond with the asset registry server 12A about the asset record template 18 for the product at a future date, for example by requesting asset records 20 related to the asset record template 18 for the asset identifier 58, or updating manufacturer content 48 associated with the asset record template 18. Upon receiving such a request for asset records 20, the asset registry server 12A is configured to transmit copies of the asset records 20 for the asset record template 18 having the asset identifier 58 to the manufacturer client device 14A. The manufacturer content 48 may be updated, for example, by uploading an updated version of the buy again link, link to purchase an accessory, link to purchase a warrantee, link to an electronic manual, and electronic manual and storing them in a manner associated with the asset identifier 58 in the asset registry database 32.

In addition, to prepare for a purchase transaction phase, the asset identifier 58 may be sent to a point-of-sale system 38. The point-of-sale system 38 may be implemented as a point-of-sale terminal in a brick-and-mortar store or in an e-commerce website or application executed on the owner client device 14B, for example. It will be appreciated that the point-of-sale system 38 maintains an asset identifier library 62 containing an asset identifier 58 for each of the products offered for sale via the point-of-sale system 38.

In the purchase transaction phase, the computer system 12 may be configured to receive at a merchant interface 50 of the asset registry server 12A an asset token request 64 along with an asset identifier 58 of the product from the point-of-sale system 38, the token request being sent in response to a purchase transaction by which an owner acquires as an asset a unit of the product at the point-of-sale system 38. In response to the asset token request 64, generate an asset token 70 based on the received asset identifier 58, and create a new asset record 20 in the asset record database 32 including the generated asset token 70 or including a link 72 to the generated asset token 70 on a publicly accessible ledger 74. The asset record registry server 12A is further configured to send the asset token 70 or the link 72 to the asset token to the point-of-sale system 38 for transmission to an owner client device 14B of the owner purchasing the product.

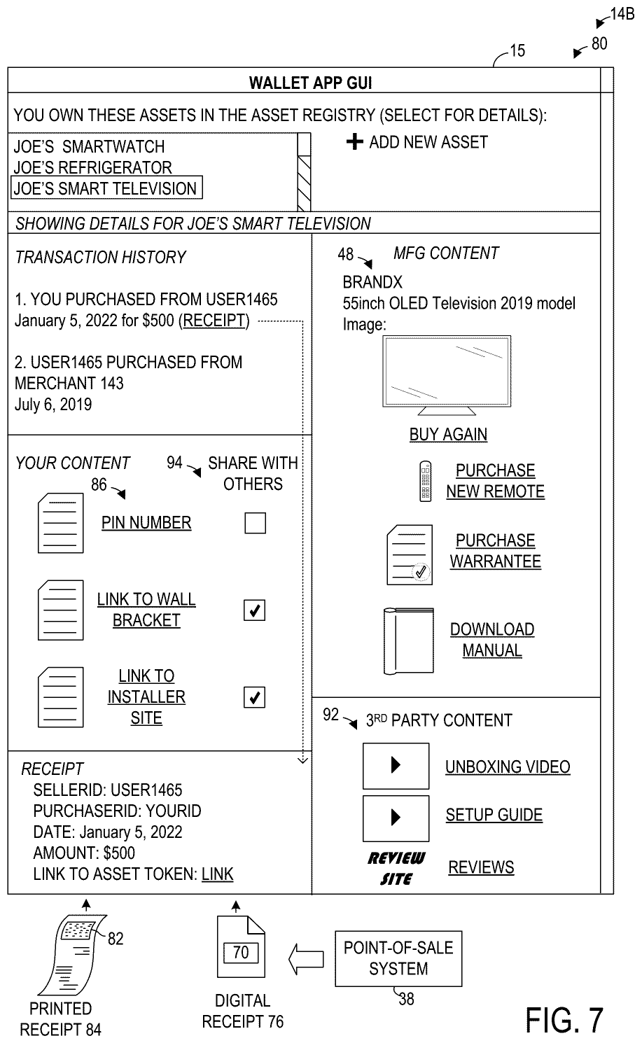

In turn, the requesting point of sale system 38 sends the asset token 70 or link 72 to the owner client device 14B. This may occur, for example, via a digital receipt 76 that includes the asset token 70 or a link 72 thereto and is sent wirelessly from the point-of-sale system 38 to the owner client device 14B, for example, over a BLUETOOTH, Near Field Communication (NFC), or WI-FI connection. A transaction engine 78 of point-of-sale system 38 can be configured to produce the digital receipt 76 for the purchase transaction for the asset 7, which includes the asset token 70 or a link 72 thereto and is sent wirelessly from the transaction engine 78 at the point-of-sale system 38 to a wallet application 80 of the owner client device 14B over a wireless connection such as those mentioned previously. Alternatively, as shown in FIG. 7, the point-of-sale system 38 is configured to produce a physical receipt 84 that includes a code or optical pattern 82 printed on the physical receipt 84, which code or optical pattern 82 is readable by a camera or other input device of the owner client device 14B. The code or optical pattern encodes a link to the asset registry server to download the asset token 70 or a link 72 to the asset token 70 on the public ledger 74, associated with the purchase transaction. The wallet application 80 of the owner client device 14B is configured to read the code or optical pattern 84 and download the asset token 70 or a link 72 to the asset token X 70 from the asset registry server 12A to the owner client device 14B.

The newly generated asset token X 70 for the purchase transaction is typically a non-fungible token, and is generated by and written to a publicly accessible blockchain ledger 74 for the asset token X 70. When the asset token is an NFT, the asset record 20 in the asset record database 32 may include a link 72 to the NFT on the blockchain, rather than the NFT itself. The transaction A from the point-of-sale system 38 of the merchant to the owner client device 14B is also recorded on the blockchain ledger 74 for the asset token X 70. Alternatively, the newly generated asset token 70 may be a globally unique identifier, and may be written to a private ledger 74A maintained by the asset registry server system 12 along with transaction A, rather than to a public blockchain ledger 74. The private ledger 74A may be maintained in the asset record database 32, or in another privately accessible database of the asset registry server system 12.

Once the owner of the asset 7 receives the asset token X 70, it is stored in the wallet application 80 of the owner client device 14B, which is configured to communicate with both the asset registry server 12A and the blockchain ledger 74. The wallet application 80 can be used by the owner to view the asset record 20 for the asset 7 owned by the owner on the asset registry server 12A, and to upload owner content 86 and/or modify metadata associated with the asset record 20. Accordingly, the asset registry server 12A is further configured to receive from the wallet application 80 executed on the owner client device 14B a request to upload the owner content 86 and/or modify metadata associated with the asset record 20 to the asset registry server 12A, and/or a request to download and view manufacturer content 48 or third-party content 92 from the asset registry server 12A, and service these requests appropriately. For example, supposing the asset 7 is a new smart television, the owner might decide to upload owner content 86 such as a user review of the smart television, or a link to a social media post for the television. These may be marked as sharable or private within the asset registry server system 12, according to sharing permissions 94 set by the owner. Any owner content 86 marked as sharable by the owner may be viewed by other users of the asset registry server system 12 who search for public information in asset records 20, for example via a web or application client 88 using a web/app interface 90 of the asset registry server 12A. The owner may also use the wallet application 80 to send an asset record request 96 to the asset registry server 12A via an owner wallet interface 100 to download and view the asset record 20 itself, manufacturer content 48 such as installation directions or other content described above, or third-party content 92 such as guides and reviews, which are shared according to the sharing permissions 94 set by the third parties.

If the owner later decides to sell the asset to a peer, then the asset token 70 can be transferred from the owner client device 14B to the peer client device 14C. Specifically, the wallet application 80 is further configured to execute a transfer transaction (transaction B) to transfer the asset token 70 or a link 72 to the asset token from the wallet application 80 of the owner client device 14B to a peer wallet application 80A of a peer client device 14C, and send a request to the blockchain ledger 74 to record the transfer transaction. In response, transaction B is recorded on the blockchain ledger 74, as shown. In turn, the peer client device 14C may make, and the asset registry server 12A is configured to receive from the peer client device 14C executing the peer wallet application 80A that has received a transfer of the asset token 70 from the owner wallet application 80, an asset record request 96 to create a new instance of an asset record 20A in the asset record database 32. In response to receiving the asset record request 96, the asset registry server 12A is configured to create a new instance of the asset record 20A associated with the asset token at the peer client device 14C in the asset record database 32. Following creation of the asset record 20A, the asset registry server 12A is further configured to receive an upload of peer content 104 from the peer client device 14C to be associated with the asset record 20A. The new instance of the asset record 20A is created with the asset token 70 or a link 72A to the asset token X 70 on the blockchain ledger 74. Sharing permissions 94 for the owner content 86 and/or peer content 104 may be uploaded by the owner client device 14B and/or peer client device 14C. The sharing permissions 94 may be used to designate the owner content 86 and/or peer content 104 as sharable so as to be viewably by other users of the asset registry server 12A, for example via a web or application client 88 via web/app interface 90.

The peer content 104 may be, as one specific example for illustration, information on an installation wall bracket and an installer company that installed the smart television for the peer user, and this information may be made sharable, for example. In this way, others using the asset registry can see the information when searching for information associated with other asset records based on the same asset record template.

Finally, a third party who owns a different instance or unit of the asset 7 may also use the asset registry server 12A to create a new instance of an asset record 20B including a different asset token Y based on the same asset record template with the same asset identifier 58 discussed above, and upload third-party content 92 and sharing permissions 94 for storage in an asset record 20B that also includes the asset token Y. Thus, the asset registry server 12A can be configured to receive, from a third-party client device 14D of a third-party owner who owns as an asset 7 another unit of the product, an asset record request 96 to create the third-party asset record 20B including the different asset token Y 70 or a link 72 to asset token Y 70 based on the asset record template 18 with the asset identifier 58. The asset registry server 12A further can be configured to receive, from the third-party client device 14D, an upload of third-party content 92 and sharing permissions 94 for the third-party content 92 associated with the third-party asset record 20B.

Further, another asset record 20C of the owner of yet another instanced of or unit of the asset 7 is shown with links 72 to an asset token Z. In the same way, hundreds, thousands, or millions of records for assets owned by users may be created from the same asset record template. Although not depicted, multiple asset record templates 18 are stored in the asset record database 32, and a dependency or linkages between the multiple asset record templates 18 may also be included, for example for different versions of products within a common product family.

Turning now to FIG. 7, an example wallet application GUI is illustrated schematically, populated with example content from the point of view of a user who has acquired an asset from another user. The asset registry server 12A is configured to serve a graphical user interface 15 including manufacturer content 48 associated with the asset record template 18 having the asset identifier 58 for the product, owner content 86 associated with the owner asset record 20 for the unit of the product, and third-party content 92 associated with the third-party asset record 20B for the different unit of the product. The user in the example depicted in FIG. 7 is named Joe, and has given nicknames to three assets (Joe's Smartwatch, Joe's refrigerator, and Joe's Smart Television) stored in the user account 22 on the asset registry server 12A. Detailed information for Joe's Smart Television is shown. For example, the transaction history for the asset 7, as determined by querying the blockchain ledger 74 for the transaction records associated with the asset token 70 that is owned by the user Joe for Joe's Smart Television. As shown, the user Joe purchased the asset from another user (User1465) on Jan. 5, 2022, for $500, and a link to a digital receipt 76 was given. A printed receipt 84 is also shown to illustrate the alternative example in which Joe could have received a printed receipt 94 with a code or optical pattern 82 printed thereon and encoding the asset token 70 or a link 72 thereto. The user's owner content 86 uploaded to the asset registry server 12A is listed in YOUR CONTENT, and includes a user PIN number (indicated as not sharable via sharing permissions 94), a link to a wall bracket for the product (indicated as sharable via sharing permissions 94), and a link to an installer for the product (also indicated as sharable via sharing permissions 94). Manufacturer content 48 is also listed on the GUI 15, and includes the brand name, product name, model year, and an image of the product, as well as a buy again link, a link to purchase a new accessory (remote), a link to purchase a warrantee for the product, and a link to download a manual for the product. It will be appreciated that the manufacturer can continuously update the data contained at each link, and thus the user will always be able to download the latest version of such information using the links provided. Finally, third party content 92 is displayed (which was uploaded with suitable sharing permissions), including an unboxing video, a setup guide, and a link to a review site.

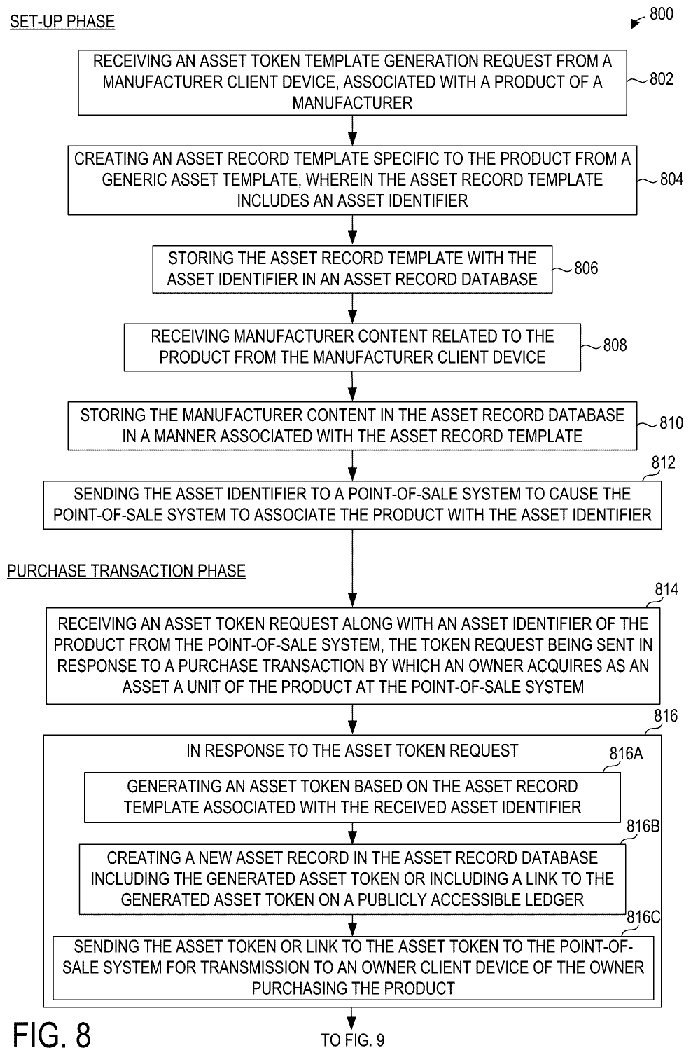

Turning now to FIG. 8, a flowchart illustrating steps in a computerized method 800 is shown. The steps in method 800 are performed at a computing device such as one or more asset registry servers 12A of asset registry server system 12 described above, or using other suitable computing hardware and software. Steps 802-812 are performed in a set-up phase in which the asset registry server and point of sale system are configured, prior to a product purchase transaction. Steps 814 and 816 are performed in a product purchase transaction phase. Steps 818-824 discuss other features of the method 800 relating to peer and third party interactions, and the graphical user interface presented by the method 800.

At 802, the method 800 includes, in the set-up phase, receiving an asset token template generation request from a manufacturer client device of a manufacturer, the request being associated with a product of the manufacturer. At 804, the method 800 includes creating an asset record template specific to the product from a generic asset template. The asset record template typically includes an asset identifier. At 806, the method 800 further includes storing the asset record template with the asset identifier in an asset record database. At 808, method 800 further includes receiving manufacturer content related to the product from the manufacturer client device. At 810, method 800 further includes storing the manufacturer content in the asset record database in a manner associated with the asset record template. At 812, the method 800 further includes sending the asset identifier to a point-of-sale system to cause the point-of-sale system to associate the product with the asset identifier.

Turning now to the purchase transaction phase, at 814, method 800 includes receiving at the asset registry server an asset token request along with an asset identifier of the product from the point-of-sale system. The token request is typically sent in response to a purchase transaction by which an owner acquires as an asset a unit of the product at the point-of-sale system. At 816, the method 800 further includes, in response to the asset token request, at 816A generating an asset token based on the asset record template associated with the received asset identifier, at 816B creating a new asset record in the asset record database including the generated asset token or including a link to the generated asset token on a publicly accessible ledger, and at 816C sending the asset token or the link to the asset token to the point-of-sale system for transmission to an owner client device of the owner purchasing the product.

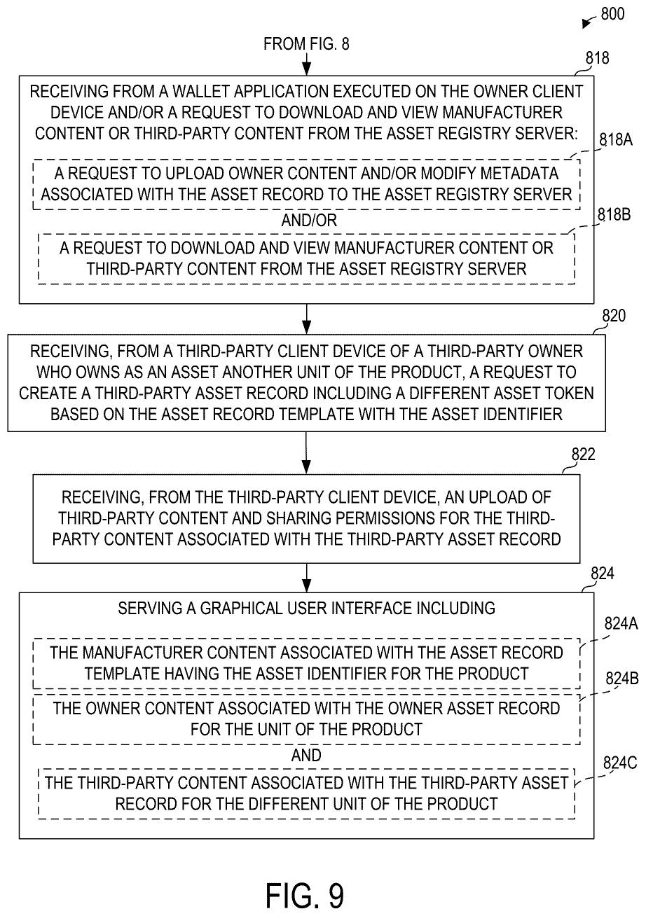

Turning now to FIG. 9, the method 800 continues at 818 with receiving from a wallet application executed on the owner client device, at 818A, a request to upload owner content and/or modify metadata associated with the asset record to the asset registry server, and/or at 818B a request to download and view manufacturer content or third-party content from the asset registry server. At 820, method 800 includes receiving, from a third-party client device of a third-party owner who owns as an asset another unit of the product, a request to create a third-party asset record including a different asset token based on the asset record template with the asset identifier. At 822, method 800 further includes receiving, from the third-party client device, an upload of third-party content and sharing permissions for the third-party content associated with the third-party asset record. Finally, at 824, method 800 includes serving a graphical user interface including, at 824A, the manufacturer content associated with the asset record template having the asset identifier for the product, at 824B, the owner content associated with the owner asset record for the unit of the product, and at 824C the third-party content associated with the third-party asset record for the different unit of the product. One such example graphical user interface is illustrated in FIG. 7, described earlier.

The systems and methods described above enable asset tokens associated with digital or physical products to be generated based on templates designed by the manufacturer/creator of such products, and further enable transfer of these digital tokens throughout the lifecycle of the products. By uploading, sharing, and accessing information stored in an asset registry of such asset tokens by the user and other users, users can quickly access the latest information related to the product they purchased, in a convenient and timely manner. This can improve the utility of the product to the user, and increase the value of the product over its lifecycle.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that can enact one or more of the methods and processes described above. Computing system 1000 is shown in simplified form. Computing system 1000 may embody the client computing devices 14, asset registry servers 12A, point of sale devices 38 and any other computing devices of computing system 10 described above. Computing system 1000 may take the form of one or more personal computers, server computers, tablet computers, home-entertainment computers, network computing devices, mobile computing devices, mobile communication devices (e.g., smart phone), and/or other computing devices.

Computing system 1000 includes a logic processor 1002 volatile memory 1004, and a non-volatile storage device 1006. Computing system 1000 may optionally include a display subsystem 1008, input subsystem 1010, communication subsystem 1012, and/or other components not shown in FIG. 10.

Logic processor 1002 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1002 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1006 includes one or more physical devices configured to hold instructions executable by the logic processors to implement the methods and processes described herein. When such methods and processes are implemented, the state of non-volatile storage device 1006 may be transformed—e.g., to hold different data.

Non-volatile storage device 1006 may include physical devices that are removable and/or built in. Non-volatile storage device 1006 may include optical memory (e.g., CD, DVD, HD-DVD, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1006 may include nonvolatile, dynamic, static, read/write, read-only, sequential-access, location-addressable, file-addressable, and/or content-addressable devices. It will be appreciated that non-volatile storage device 1006 is configured to hold instructions even when power is cut to the non-volatile storage device 1006.

Volatile memory 1004 may include physical devices that include random access memory. Volatile memory 1004 is typically utilized by logic processor 1002 to temporarily store information during processing of software instructions. It will be appreciated that volatile memory 1004 typically does not continue to store instructions when power is cut to the volatile memory 1004.

Aspects of logic processor 1002, volatile memory 1004, and non-volatile storage device 1006 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 typically implemented in software by a processor to perform a particular function using portions of volatile memory, which function involves transformative processing that specially configures the processor to perform the function. Thus, a module, program, or engine may be instantiated via logic processor 1002 executing instructions held by non-volatile storage device 1006, using portions of volatile memory 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1008 may be used to present a visual representation of data held by non-volatile storage device 1006. The visual representation may take the form of a graphical user interface (GUI). As the herein described methods and processes change the data held by the non-volatile storage device, and thus transform the state of the non-volatile storage device, the state of display subsystem 1008 may likewise be transformed to visually represent changes in the underlying data. Display subsystem 1008 may include one or more display devices utilizing virtually any type of technology. Such display devices may be combined with logic processor 1002, volatile memory 1004, and/or non-volatile storage device 1006 in a shared enclosure, or such display devices may be peripheral display devices.

When included, input subsystem 1010 may comprise or interface with one or more user-input devices such as a keyboard, mouse, or touch screen. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition: an infrared, color, stereoscopic, and/or depth camera for machine vision and/or gesture recognition: a head tracker, eye tracker, accelerometer, and/or gyroscope for motion detection and/or intent recognition, etc.

When included, communication subsystem 1012 may be configured to communicatively couple various computing devices described herein with each other, and with other devices. Communication subsystem 1012 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet. In addition, the communication subsystem may be configured for wireless communications over WI-FI, BLUETOOTH, or near field communications protocols. For example, the point-of-sale system 38 can communicate with the owner client device 14B using any of these wireless technologies or via a camera and displayed or printed QR code, as some examples.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A computerized system, comprising:
an asset registry server including one or more processors each having associated memory storing instructions that when executed cause the one or more processors to:
in a set-up phase:
receive an asset token template generation request from a manufacturer client device, the request being associated with a product of a manufacturer;
create an asset record template specific to the product from a generic asset template, wherein the asset record template includes an asset identifier;
store the asset record template with the asset identifier in an asset record database;
receive manufacturer content related to the product from the manufacturer client device;
store the manufacturer content in the asset record database in a manner associated with the asset record template;
send the asset identifier to a point-of-sale system to cause the point-of-sale system to associate the product with the asset identifier;
in a purchase transaction phase:
receive at the asset registry server an asset token request along with an asset identifier of the product from the point-of-sale system, the token request being sent in response to a purchase transaction by which an owner acquires as an asset a unit of the product at the point-of-sale system; and
in response to the asset token request,
generate an asset token based on the asset record template associated with the received asset identifier;
create a new asset record in the asset record database including the generated asset token or including a link to the generated asset token on a publicly accessible ledger; and
send the asset token or a link to the asset token to the point-of-sale system for transmission to an owner client device of the owner purchasing the product.

2. The computerized system of claim 1, wherein the manufacturer content includes one or more of a buy again link for the product, a link to purchase an accessory for the product, a link to purchase a warrantee for the product, a link an electronic manual for the product, and/or an electronic manual for the product.

3. The computerized system of claim 1, wherein the point-of-sale system is a point-of-sale terminal in a brick-and-mortar store.

4. The computerized system of claim 1, wherein the point-of-sale system is configured to produce a digital receipt for the purchase transaction that includes the asset token or a link to the asset token and is sent wirelessly from the point-of-sale system to an owner client device.

5. The computerized system of claim 1, wherein the point-of-sale system is configured to produce a physical receipt that includes a code or optical pattern printed on the physical receipt, which code or optical pattern is readable by a camera or other input device of an owner client device, the owner client device being configured to read the code or optical pattern and download the asset token from the asset registry server.

6. The computerized system of claim 1, wherein the point-of-sale system is an e-commerce website or application executed on an owner client device.

7. The computerized system of claim 1, wherein the asset token is a non-fungible token, and is generated by and written to a publicly accessible blockchain ledger, and the asset record in the asset record database includes a link to the non-fungible token on the blockchain ledger.

8. The computerized system of claim 7, wherein a record of the purchase transaction from the point-of-sale system of the merchant to the owner client device is also recorded on the blockchain ledger for the asset token.

9. The computerized system of claim 1, wherein the asset token is a globally unique identifier, and is written to a private ledger maintained by the asset registry system along with the purchase transaction.

10. The computerized system of claim 1, wherein the asset registry server is further configured to receive from a wallet application executed on the owner client device:
a request to upload owner content and/or modify metadata associated with the asset record to the asset registry server; and/or
a request to download and view manufacturer content or third-party content from the asset registry server.

11. The computerized system of claim 10, wherein the wallet application is further configured to execute a transfer transaction to transfer the asset token from the wallet application of the owner client device to a peer wallet application of a peer client device, and send a request to the blockchain ledger to record the transfer transaction.

12. The computerized system of claim 11, wherein the asset registry server is further configured to
receive, from a peer client device executing a peer wallet application that has received a transfer of the asset token from the owner wallet application, an asset record request;
in response to receiving the asset record request, create an asset record associated with the asset token at the peer client device in the asset record database; and
following creation of the asset record request is further configured to receive an upload of peer content from the peer client device to be associated with the asset record.

13. The computerized system of claim 12, wherein the owner content and/or peer content is designated as sharable so as to be viewably by other users of the asset registry server.

14. The computerized system of claim 1, wherein the asset registry server is configured to:
receive, from a third-party client device of a third-party owner who owns as an asset another unit of the product, a request to create a third-party asset record including a different asset token based on the asset record template with the asset identifier; and
receive, from the third-party client device, an upload of third-party content and sharing permissions for the third-party content associated with the third-party asset record.

15. The computerized system of claim 14, wherein the asset registry server is configured to serve a graphical user interface including:
manufacturer content associated with the asset record template having the asset identifier for the product;
owner content associated with the owner asset record for the unit of the product; and
third-party content associated with the third-party asset record for the different unit of the product.

16. A computerized method, comprising:
at an asset registry server:
in a set-up phase:
receiving an asset token template generation request from a manufacturer client device of a manufacturer, the request being associated with a product of the manufacturer;
creating an asset record template specific to the product from a generic asset template, wherein the asset record template includes an asset identifier;
storing the asset record template with the asset identifier in an asset record database;
receiving manufacturer content related to the product from the manufacturer client device;
storing the manufacturer content in the asset record database in a manner associated with the asset record template;
sending the asset identifier to a point-of-sale system to cause the point-of-sale system to associate the product with the asset identifier;
in a purchase transaction phase:
receiving at the asset registry server an asset token request along with an asset identifier of the product from the point-of-sale system, the token request being sent in response to a purchase transaction by which an owner acquires as an asset a unit of the product at the point-of-sale system; and
in response to the asset token request,
generating an asset token based on the asset record template associated with the received asset identifier;
creating a new asset record in the asset record database including the generated asset token or including a link to the generated asset token on a publicly accessible ledger; and
sending the asset token or a link to the asset token to the point-of-sale system for transmission to an owner client device of the owner purchasing the product.

17. The computerized method of claim 16, further comprising:
receiving from a wallet application executed on the owner client device:
a request to upload owner content and/or modify metadata associated with the asset record to the asset registry server; and/or
a request to download and view manufacturer content or third-party content from the asset registry server.

18. The computerized method of claim 17, further comprising:
receiving, from a third-party client device of a third-party owner who owns as an asset another unit of the product, a request to create a third-party asset record including a different asset token based on the asset record template with the asset identifier; and
receiving, from the third-party client device, an upload of third-party content and sharing permissions for the third-party content associated with the third-party asset record.

19. The computerized method of claim 18, further comprising:
serving a graphical user interface including:
the manufacturer content associated with the asset record template having the asset identifier for the product;
the owner content associated with the owner asset record for the unit of the product; and
the third-party content associated with the third-party asset record for the different unit of the product.

20. A computerized system, comprising:
an asset registry server including one or more processors each having associated memory storing instructions that when executed cause the one or more processors to:
in a set-up phase:
receive an asset token template generation request from a manufacturer client device, the request being associated with a product of a manufacturer;
create an asset record template specific to the product from a generic asset template, wherein the asset record template includes an asset identifier;
store the asset record template with the asset identifier in an asset record database;
receive manufacturer content related to the product from the manufacturer client device, wherein the manufacturer content includes one or more of a buy again link for the product, a link to purchase an accessory for the product, a link to purchase a warrantee for the product, a link an electronic manual for the product, and/or an electronic manual for the product;
store the manufacturer content in the asset record database in a manner associated with the asset record template;
send the asset identifier to a point-of-sale system to cause the point-of-sale system to associate the product with the asset identifier;
in a purchase transaction phase:
receive at the asset registry server an asset token request along with an asset identifier of the product from the point-of-sale system, the token request being sent in response to a purchase transaction by which an owner acquires as an asset a unit of the product at the point-of-sale system; and
in response to the asset token request,
generate an asset token based on the asset record template associated with the received asset identifier, wherein the asset token is a non-fungible token, and is generated by and written to a publicly accessible blockchain ledger, and the asset record in the asset record database includes a link to the non-fungible token on the blockchain ledger;
create a new asset record in the asset record database including the generated asset token or including a link to the generated asset token on a publicly accessible ledger; and
send the asset token or a link to the asset token to the point-of-sale system for transmission to an owner client device of the owner purchasing the product, wherein said transmission to the owner client device occurs via a physical or digital receipt for the purchase transaction that includes the asset token or the link to the asset token.
